(19) United States
(12) Patent Application Publication
(10) Pub. No.: US 2023/0352230 A1
(43) Pub. Date: Nov. 2, 2023

(54) COIL COMPONENT

(71) Applicant: Murata Manufacturing Co., Ltd., Kyoto-fu (JP)

(72) Inventors: Yuuki KAWAKAMI, Nagaokakyo-shi (JP); Ryuichiro TOMINAGA, Nagaokakyo-shi (JP); Keisuke KUNIMORI, Nagaokakyo-shi (JP); Yoshimasa YOSHIOKA, Nagaokakyo-shi (JP)

(73) Assignee: Murata Manufacturing Co., Ltd., Kyoto-fu (JP)

(21) Appl. No.: 18/307,485

(22) Filed: Apr. 26, 2023

(30) Foreign Application Priority Data
May 2, 2022 (JP) 2022-076228

(51) Int. Cl. H01F 27/28; H01F 17/00; H01F 27/29

(52) U.S. Cl. CPC H01F 27/2804; H01F 17/0013; H01F 27/292

(57) ABSTRACT

A coil component includes an insulating layer that has a main surface; and a circuit pattern that is embedded in the insulating layer and extends along the main surface. The circuit pattern includes a seed pattern that extends along the main surface within the circuit pattern, and in a cross section orthogonal to an extending direction of the circuit pattern, the circuit pattern has a part in which the number of seed patterns is two or more.

### CROSS-REFERENCE TO RELATED APPLICATION

This application claims benefit of priority to Japanese Patent Application No. 2022-076228, filed May 2, 2022, the entire content of which is incorporated herein by reference.

### BACKGROUND

### Technical Field

The present disclosure relates to a coil component.

### Background Art

In the related art, a coil component formed by embedding in a resin that contains magnetic powder, a wiring layer that includes a spiral circuit pattern formed by plating wiring is known as described, for example, in Japanese Unexamined Patent Application Publication No. 2016-225463. In the wiring layer of this coil component, the spiral circuit pattern is formed by plating growth from one seed pattern between each of a plurality of insulator walls and an adjacent insulator wall formed on an insulating layer.

### SUMMARY

In the wiring layer of the coil component described above, only one seed pattern having a constant width is formed between insulator walls adjacent to each other, and therefore, in two parts in which the space between insulator walls adjacent to each other differs from part to part, that is, in two parts in which the width of a circuit pattern formed between the insulator walls by plating differs from part to part, the thickness of the circuit pattern varies. For a similar reason, when a wider pad part for a connection with a via conductor connected to another wiring layer is formed at both end portions of the circuit pattern, the thickness of the pad part is thinner than the thickness of the other part of the circuit pattern in accordance with the width of the pad part. Such a part in which the thickness of the circuit pattern is thinner is filled with a larger amount of an insulating material for covering the circuit pattern than in the other part in order to make the upper surface of the wiring layer flat, and therefore, the proportion of resin in the entire coil component may increase and the upper limit of an attainable inductance may be limited.

FIG. 12 is a diagram of the related art and illustrates an example where the thickness of a circuit pattern formed by plating changes in accordance with a width. FIG. 12 shows a cross section along a plane orthogonal to the extending direction of the circuit pattern. FIG. 12 illustrates three circuit patterns 41a, 41b, and 41c formed on a substrate 40. The circuit patterns 41a, 41b, and 41c form a part of one circuit pattern 41 that is formed so as to be spiral in plan view when viewed from an upper part in the drawing.

On the substrate 40, four insulator walls 42a, 42b, 42c, and 42d are formed, and on the surface of the substrate 40, one seed pattern 43 having a constant width is formed in each of the three spaces separated by the walls 42a, 42b, 42c, and 42d. These seed patterns 43 form a part of one seed pattern formed along the circuit pattern 41 having a spiral shape.

In FIG. 12, the widths of the three spaces separated by the four insulator walls 42a, 42b, 42c, and 42d are different from each other, and the width increases from the right-hand space to the left-hand space in the drawing. Accordingly, the circuit patterns simultaneously formed by plating growth from the seed patterns 43 have thicknesses such that the circuit pattern 41c in the right-hand space in the drawing having the narrowest width is thickest and the circuit pattern 41a in the left-hand space in the drawing is thinnest.

In the circuit pattern 41a that is formed and is the widest and thinnest part, the surface shape of the upper surface of the circuit pattern 41a formed by plating growth is not flat but is a convex upward curve depending on the width. Accordingly, when, for example, another circuit pattern is formed in a part above the circuit pattern 41a, it may be difficult to obtain the other circuit pattern having a flat upper surface (for example, a flat outer electrode surface).

Accordingly, the present disclosure provides a coil component including a circuit pattern in which the uniformity of the structure including the thickness and/or surface shape of the circuit pattern is improved.

According to one aspect of the present disclosure, a coil component includes an insulating layer that has a main surface; and a circuit pattern that is embedded in the insulating layer and extends along the main surface. The circuit pattern includes a seed pattern that extends along the main surface within the circuit pattern, and in a cross section orthogonal to an extending direction of the circuit pattern, the circuit pattern has a part in which the number of seed patterns is two or more.

According to the present disclosure, it is possible to provide a coil component including a circuit pattern in which the uniformity of the structure including the thickness and/or surface shape of the circuit pattern is improved.

### BRIEF DESCRIPTION OF THE DRAWINGS

FIG. 1 is a schematic diagram illustrating an internal structure of a coil component according to a first embodiment of the present disclosure;

FIG. 2 is a detailed diagram of a circuit pattern in part A in FIG. 1;

FIG. 3 is a plan view of a seed pattern in the circuit pattern illustrated in FIG. 2;

FIG. 4 is a diagram illustrating steps for manufacturing the coil component illustrated in FIG. 1;

FIG. 5 is a diagram illustrating steps continued from FIG. 4 for manufacturing the coil component illustrated in FIG. 1;

FIG. 6 is a diagram illustrating steps continued from FIG. 5 for manufacturing the coil component illustrated in FIG. 1;

FIG. 7 is a diagram illustrating a configuration of a circuit pattern according to a first modification;

FIG. 8 is a diagram illustrating a configuration of a circuit pattern according to a second modification;

FIG. 9 is a diagram illustrating a configuration of a circuit pattern according to a third modification;

FIG. 10 is a diagram illustrating a configuration of a circuit pattern according to a fourth modification;

FIG. 11 is a schematic diagram illustrating an internal structure of a coil component according to a second embodiment of the present disclosure; and

FIG. 12 is a diagram for explaining a wiring layer according to the related art of the present disclosure.

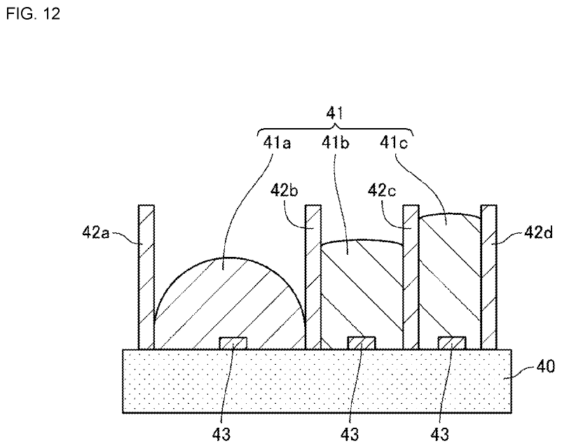

### DETAILED DESCRIPTION

Hereinafter, embodiments of the present disclosure will be described with reference to the drawings.

Note that the drawings may include some schematic diagrams. Further, dimensions and ratios in the schematic diagrams may be different from actual numerical values.

### First Embodiment

First, a first embodiment will be described.

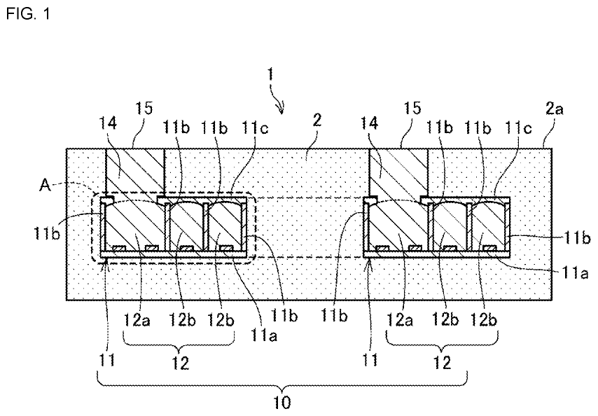

FIG. 1 is a schematic diagram illustrating an internal structure of a coil component 1 according to this embodiment.

The coil component 1 includes an insulating layer 11 and a circuit pattern 12 having a spiral shape and embedded in the insulating layer 11. The insulating layer 11 and the circuit pattern 12 form a wiring layer 10 having a ring shape and formed of one layer. FIG. 1 shows a cross section along a plane orthogonal to the extending direction of the circuit pattern 12. The cross section along a plane orthogonal to the extending direction of the circuit pattern 12 is hereinafter referred to as a width-direction cross section of the circuit pattern 12.

The insulating layer 11 is made of an insulating material, which is a main material, and is, for example, an insulating resin. Note that the insulating material may contain a filler that contains silicon oxide (SiO₂) or aluminum oxide (Al₂O₃) as a main material.

The wiring layer 10 is embedded in a base body 2 that is a resin containing magnetic powder. The main-surface direction of the base body 2 and the main-surface direction of the insulating layer 11 are substantially parallel to each other.

The circuit pattern 12 is one conductor that is formed along the main-surface direction of the insulating layer 11 so as to be spiral and forms a coil part. The insulating layer 11 includes a bottom cover layer 11a that extends in the main-surface direction and that covers the lower surface of the circuit pattern 12, a plurality of insulating walls 11b between which each of the parts of the circuit pattern 12 is sandwiched in the main-surface direction, and a top cover layer 11c that covers the insulating walls 11b and the circuit pattern 12 on a side opposite to the bottom cover layer 11a.

A pad part 12a, which is a part of the circuit pattern 12, is connected to a lead line 14. The lead line 14 extends up to the surface of one main surface of the base body 2, and the end surface of the lead line 14 exposed from the surface functions as an outer electrode 15. The main surface of the base body 2 on which the outer electrode 15 is provided is referred to as an electrode surface 2a. The width of the pad part 12a of the circuit pattern 12 connected to the lead line 14 is wider than the width of other circuit parts 12b of the circuit pattern 12.

A main surface of the insulating layer 11 may have irregularities in its plane. A main surface of the wiring layer 10 may have distortions when viewed in cross section that includes a direction normal to the main surface.

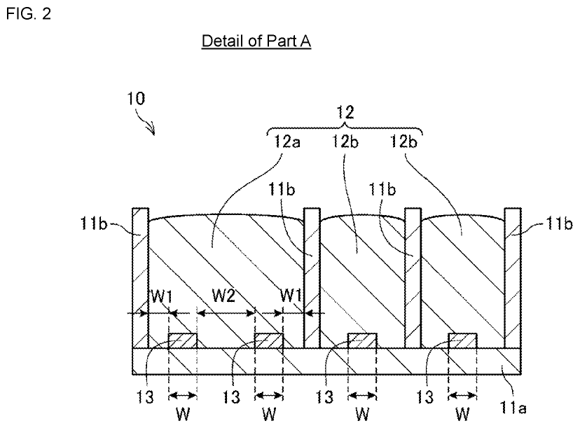

FIG. 2 is a partial detailed diagram of the circuit pattern 12 of the wiring layer 10 in part A illustrated in FIG. 1. In FIG. 2, the base body 2, the top cover layer 11c, and the lead line 14 are omitted.

The circuit pattern 12 includes a seed pattern 13 that extends along the circuit pattern 12 on the upper surface of the bottom cover layer 11a, which is one surface along a main surface of the insulating layer 11. The circuit pattern 12 is formed with, for example, the SAP (Semi-Additive Process), and the seed pattern 13 is a feeder electrode that is used in plating growth with the SAP. The material of the circuit pattern 12 except for the seed pattern 13 is, for example, copper, and the material of the seed pattern 13 is, for example, copper, titanium, chromium, or an alloy thereof.

In this embodiment, specifically in at least one part of the circuit pattern 12 along the extending direction of the circuit pattern 12, the number of seed patterns 13 when viewed in the width-direction cross section of the circuit pattern 12 is two or more. Accordingly, in a part of the circuit pattern 12 that includes the cross section described above in which the number of seed patterns 13 is two or more, plating grows from each of the seed patterns 13, and therefore, as the number of seed patterns 13 increases, the flatness of the surface of the part of the circuit pattern 12 increases. When the number of seed patterns 13 and the widths of the respective seed patterns 13 are adjusted in accordance with the space between the insulating walls 11b, the thickness of the circuit pattern 12 in the part can be adjusted, and the uniformity of the thickness of the circuit pattern 12 along the extending direction can be improved. Here, the surface of the circuit pattern 12 is a surface opposite to a surface of the circuit pattern 12 on which the seed patterns 13 are formed.

Specifically, in the coil component 1 in FIG. 2, the number of seed patterns 13 when viewed in the width-direction cross section of the circuit pattern 12 is one in the circuit parts 12b of the circuit pattern 12 and two in the pad part 12a that is wider than the circuit parts 12b.

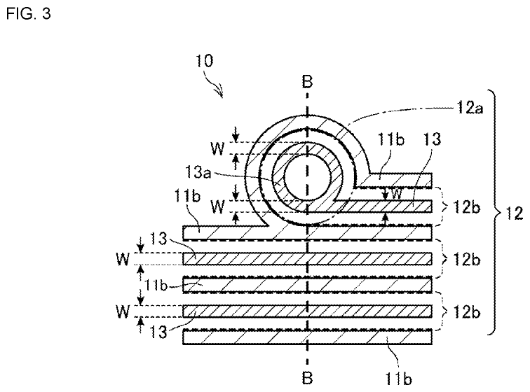

FIG. 3 is a plan view of the seed pattern 13 included in the circuit pattern 12 when viewed from the electrode surface 2a of the base body 2. The detailed diagram of part A illustrated in FIG. 2 corresponds to a cross-sectional view taken along line BB in FIG. 3.

In FIG. 3, the region that is represented by the dashed dotted line in the drawing and in which the pad part 12a of the circuit pattern 12 is formed has a round shape in plan view, and the seed pattern 13 is terminated in the pad part 12a with a ring pattern 13a having a ring shape concentric with the pad part 12a. In FIG. 2 and FIG. 3, the seed pattern 13 including the ring pattern 13a has a constant width W.

In the coil component 1 having the configuration described above, the number of seed patterns 13 in the width-direction cross section of the circuit pattern 12 is one in the circuit parts 12b and two in the pad part 12a, which is wider than the circuit parts 12b, and therefore, in the pad part 12a, which is a wider part, it is possible to reduce the possibility of the flatness of the surface shape (the uniformity of the thickness) of the circuit pattern 12 being compromised and the thickness of the circuit pattern 12 being decreased compared with the circuit part 12b. As a result, in the coil component 1, it is possible to increase the reliability of the connection between the circuit pattern 12 and the lead line 14, prevent the thickness of the top cover layer 11c from being increased, and improve the stability of electric characteristics including an inductance value and/or a DC resistance upon manufacturing.

As illustrated in FIG. 2, from the viewpoint of improving the flatness of the surface of the circuit pattern 12, in the width-direction cross section of the circuit pattern 12, with respect to two or more seed patterns 13 and one of or both the two insulating walls 11b between which the circuit pattern 12 is sandwiched along the arrangement direction of the seed patterns 13, the distance W1 from one insulating wall 11b to the seed pattern 13 closest to the insulating wall 11b and the space W2 between the seed patterns 13 preferably have a relationship expressed by expression (1) below.

W1×2<W2 (1)

Note that the preferable relationship expressed by expression (1) is applicable not only to the pad part 12a formed so as to have a round shape in plan view but also to the circuit part 12b that extends in one direction as long as two or more seed patterns 13 are present. Note that expression (1) covers a case of W1=0.

The coil component 1 can be manufactured as follows.

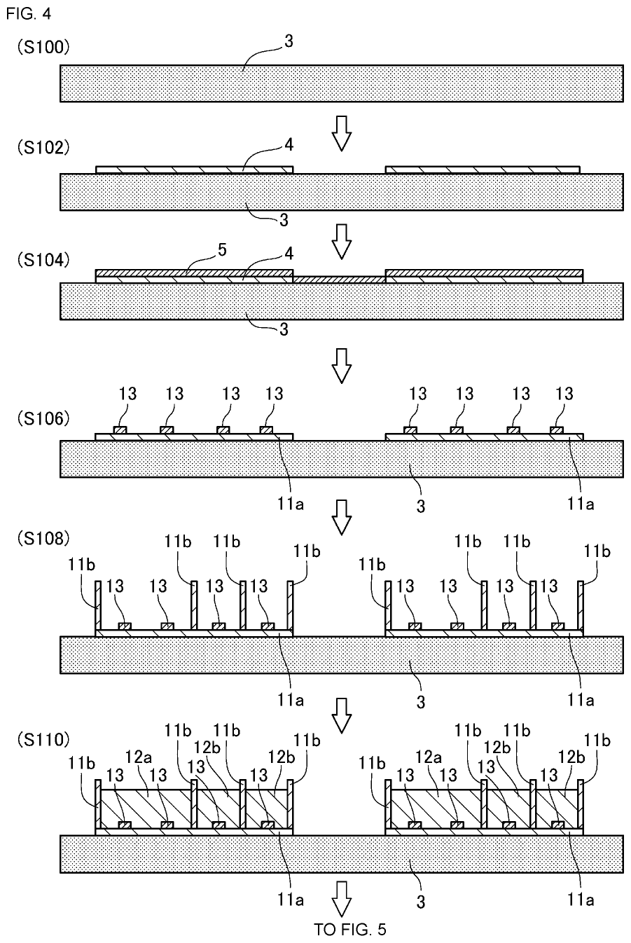

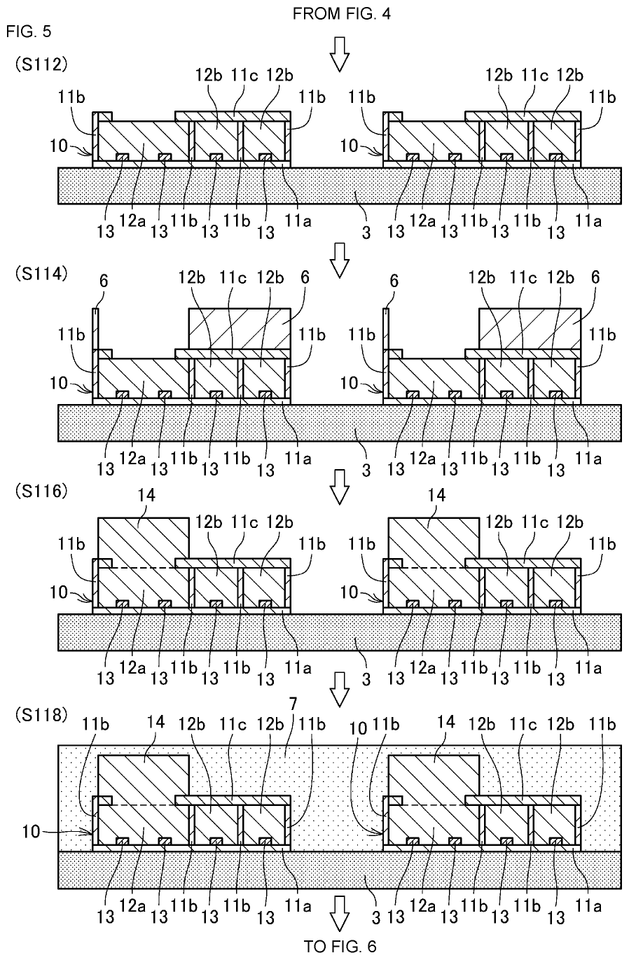

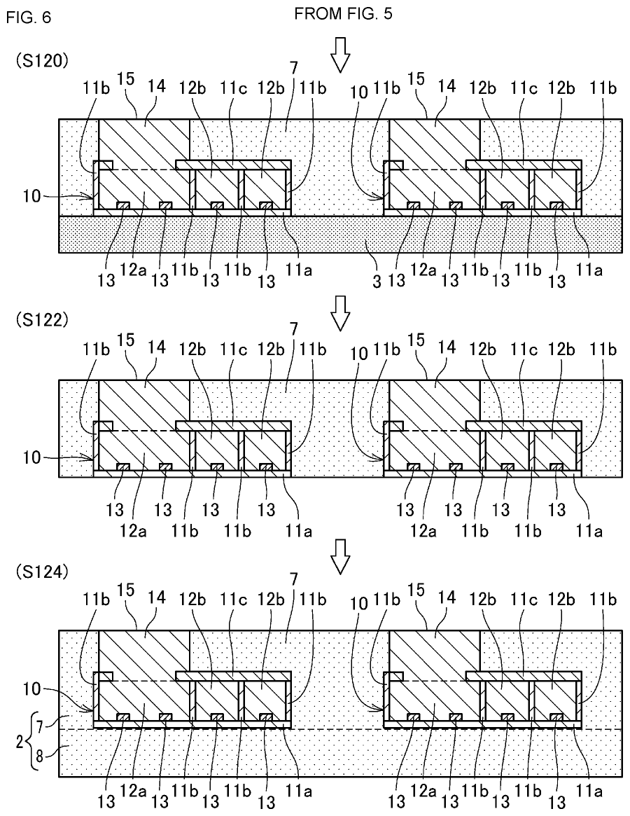

FIG. 4, FIG. 5, and FIG. 6 are diagrams illustrating steps for manufacturing the coil component 1.

In FIG. 4, first, a substrate 3 is prepared (S100). The substrate 3 is, for example, a flat ceramic board. Next, the substrate 3 is coated with a photosensitive insulating resin, such as a polyimide resin, and thereafter, is subjected to patterning with photolithography to form the bottom cover layer 11a of the insulating layer 11 (S102), and a seed layer 5 is formed on top of the bottom cover layer 11a (S104). The seed layer 5 is a feeder electrode made of copper for plating growth with the SAP and can be formed by sputtering or electroless plating. Note that the seed layer 5 may have a layered structure including a layer that is made of copper and an alloy layer that is formed under the copper layer and contains titanium and chromium attaining highly close contact with the bottom cover layer 11a.

Next, the seed layer 5 is subjected to patterning with photolithography to form the seed pattern 13 (S106). The seed pattern 13 is a part from which the circuit pattern 12 is formed by plating growth in a later step, and is formed on the bottom cover layer 11a so as to be in a pattern similar to the circuit pattern 12, which is a target. In this embodiment, the pattern described above is a spiral pattern for forming the circuit pattern 12 as a coil part.

Next, on the bottom cover layer 11a, the insulating walls 11b are formed at positions such that one or more seed patterns 13 are sandwiched therebetween (S108). Specifically, the insulating resin 4 is formed so as to be thick to cover the bottom cover layer 11a and the seed patterns 13, and thereafter, is subjected to patterning to form the insulating walls 11b. The space between the insulating walls 11b defines the width of the circuit pattern 12 that is formed in a later step in a cavity part or a gap part between the insulating walls 11b.

Subsequently, along the cavity between the insulating walls 11b adjacent to each other, one or more seed patterns 13 are used to make copper plating grow by electrolytic plating to form the circuit pattern 12 (S110). In this embodiment, in each of the left part and the right part on the substrate 3 in the drawing, the pad part 12a and two circuit parts 12b of the circuit pattern 12 are formed from the left side.

In this embodiment, the pattern of the seed patterns 13 and the insulating walls 11b are designed in advance such that specifically on the bottom cover layer 11a between the insulating walls 11b adjacent to each other, a specific number of seed patterns 13 and/or the seed pattern 13 having a specific width corresponding to the space between the insulating walls 11b are formed. Therefore, the pad part 12a of the circuit pattern 12 formed by plating growth in step S110 can have a flat upper surface, and the pad part 12a and the circuit parts 12b can be formed so as to have the same thicknesses even though the widths thereof are different.

Referring to FIG. 5, next, the top cover layer 11c is formed so as to cover the insulating walls 11b and the circuit pattern 12 (specifically, the pad part 12a and the two circuit parts 12b) (S112). Specifically, the insulating resin 4 is formed so as to cover the insulating walls 11b and the circuit pattern 12, and thereafter, the insulating resin 4 is subjected to patterning with photolithography to remove unwanted portions and form the top cover layer 11c. At this time, the patterning described above is performed such that a cavity is formed in a part of the top cover layer 11c above the pad part 12a. Accordingly, the wiring layer 10 formed of the circuit pattern 12 including the pad part 12a and the circuit parts 12b and embedded in the insulating layer 11 formed of the bottom cover layer 11a, the insulating walls 11b, and the top cover layer 11c is formed on the substrate 3.

Next, the top portion of the top cover layer 11c is coated with a resist 6, and photolithography is performed to form a cavity in a part above the pad part 12a (S114). Subsequently, the lead line 14 is formed by plating growth of copper in the part above the pad part 12a, and thereafter, the resist 6 is removed (S116). Thereafter, an upper magnetic layer 7 that forms the upper half of the base body 2 in the drawing is formed so as to entirely cover the wiring layer 10 formed on the substrate 3 and the lead line 14 (S118).

Referring to FIG. 6, next, the outer surface of the upper magnetic layer 7 is ground to thereby expose the upper surface of the lead line 14 from the upper magnetic layer 7 to form the outer electrode 15 (S120). Subsequently, the substrate 3 is taken off (S122), and thereafter, a lower magnetic layer 8 that forms the lower half of the base body 2 is formed on the lower side of the upper magnetic layer 7 in the drawing (S124). Accordingly, the wiring layer 10 and the lead line 14 are embedded in the base body 2 that includes the upper magnetic layer 7 and the lower magnetic layer 8, and the coil component 1 is completed. Note that after formation of the lower magnetic layer 8, the base body 2 may be chamfered or surface-treated.

Next, some modifications of the circuit pattern 12 in the coil component 1 will be described. Circuit patterns according to modifications described below can be used in the coil component 1 instead of the circuit pattern 12. The coil component 1 that includes any of the circuit patterns according to the modifications can be manufactured with a manufacturing method similar to the manufacturing method, illustrated in FIG. 4, FIG. 5, and FIG. 6, for the coil component 1 that includes the circuit pattern 12.

First Modification

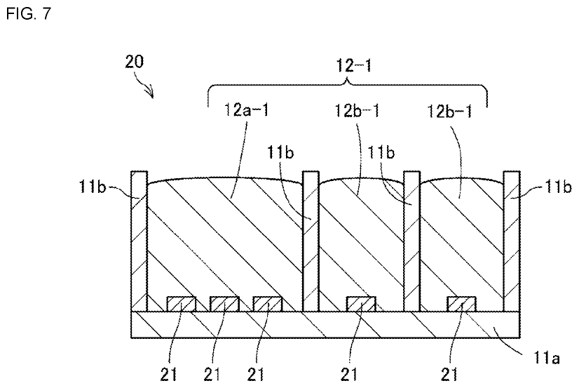

FIG. 7 is a diagram illustrating a configuration of a circuit pattern 12-1 according to a first modification of the circuit pattern 12. FIG. 7 is a cross-sectional view showing a width-direction cross section of a wiring layer 20 that includes the circuit pattern 12-1 and is a diagram corresponding to FIG. 2 that illustrates the wiring layer 10 in detail. In FIG. 7, constituent elements the same as those of the circuit pattern 12 and the wiring layer 10 illustrated in FIG. 2 are indicated by numerals the same as those in FIG. 2, and the description of FIG. 2 given above is to be cited. Note that in FIG. 7, the base body 2, the top cover layer 11c, and the lead line 14 are not illustrated as in FIG. 2.

The circuit pattern 12-1 illustrated in FIG. 7 includes a pad part 12a-1 and circuit parts 12b-1. Although the pad part 12a-1 and the circuit parts 12b-1 of the circuit pattern 12-1 have configurations similar to those of the pad part 12a and the circuit parts 12b of the circuit pattern 12 illustrated in FIG. 2, seed patterns 21 are formed on the bottom cover layer 11a instead of the seed patterns 13.

Although the seed patterns 21 have a configuration similar to that of the seed patterns 13, a difference from the seed patterns 13 is that the number of seed patterns 21 in the pad part 12a-1 is three.

Accordingly, in the circuit pattern 12-1, variations in the thickness in the pad part 12a-1 that is formed and is wider can be further reduced compared with the circuit pattern 12, and the flatness of the surface shape of the pad part 12a-1 can be further improved.

Note that the seed patterns 21 can be formed by, for example, forming a disk-shaped conductor pattern in the center portion of the ring of the ring pattern 13a in the seed pattern 13 illustrated in FIG. 3. In the disk-shaped conductor pattern described above, for example, a part of the circumference thereof can be electrically connected to the ring pattern 13a by a bridge conductor (not illustrated) that is provided between the part of the circumference and a part of the internal circumference of the ring pattern 13a.

Second Modification

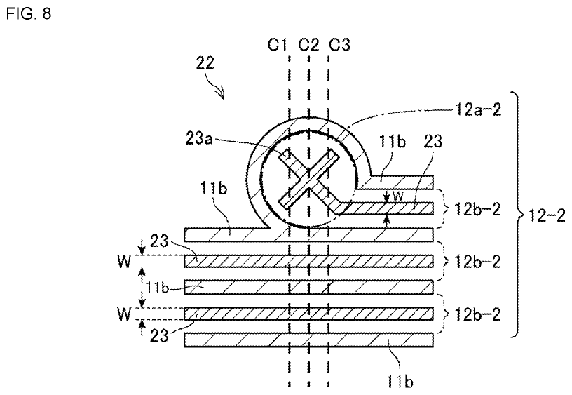

FIG. 8 is a diagram illustrating a configuration of a circuit pattern 12-2 according to a second modification of the circuit pattern 12 and is a diagram corresponding to FIG. 3 that illustrates the configuration of the circuit pattern 12. Note that in FIG. 8, constituent elements the same as those of the wiring layer 10 illustrated in FIG. 3 are indicated by numerals the same as those in FIG. 3, and the description of FIG. 3 given above is to be cited.

The circuit pattern 12-2 illustrated in FIG. 8 includes a pad part 12a-2 and circuit parts 12b-2. Although the pad part 12a-2 and the circuit parts 12b-2 of the circuit pattern 12-2 have configurations similar to those of the pad part 12a and the circuit parts 12b of the circuit pattern 12, a difference is that that a seed pattern 23 is included instead of the seed pattern 13. Although the seed pattern 23 has a configuration similar to that of the seed pattern 13, unlike in the seed pattern 13, the seed pattern 23 is terminated with a cross pattern 23a having an X letter shape in plan view, in the round region that is represented by the dashed dotted line in the drawing and in which the pad part 12a-2 of the circuit pattern 12-2 is formed.

In the circuit pattern 12-2 having the configuration described above, when viewed in cross sections along line C1, C2, and C3 that pass through the pad part 12a-2, which is a wider part, as illustrated in FIG. 8, the two arms of the cross pattern 23a are included in at least the cross sections along line C1 and line C3, and therefore, the structural uniformity in terms of the surface shape and thickness of the circuit pattern 12-2 can be improved compared with the configuration in which one seed pattern is included in the cross sections.

Third Modification

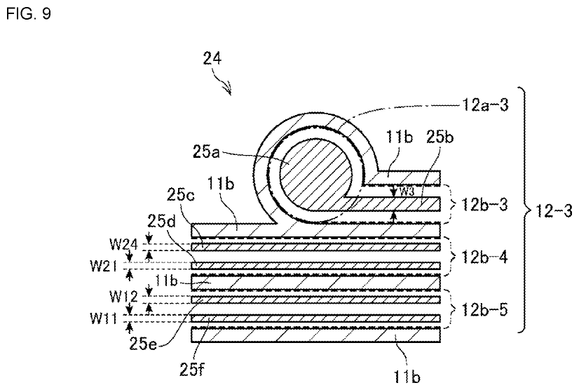

FIG. 9 is a diagram illustrating a configuration of a circuit pattern 12-3 according to a third modification of the circuit pattern 12 and is a diagram corresponding to FIG. 3 that illustrates the configuration of the circuit pattern 12. Note that in FIG. 9, constituent elements the same as those of the wiring layer 10 illustrated in FIG. 3 are indicated by numerals the same as those in FIG. 3, and the description of FIG. 3 given above is to be cited.

The circuit pattern 12-3 illustrated in FIG. 9 includes a pad part 12a-3 and circuit parts 12b-3, 12b-4, and 12b-5. The circuit part 12b-3 is a part connected to the pad part 12a-3. The circuit part 12b-4 is a part adjacent to the circuit part 12b-3, and the circuit part 12b-5 is a part adjacent to the circuit part 12b-4.

Although the pad part 12a-3 and the circuit parts 12b-3, 12b-4, and 12b-5 of the circuit pattern 12-3 have configurations similar to those of the pad part 12a and the circuit parts 12b of the circuit pattern 12, a difference is that a seed pattern 25 is included instead of the seed pattern 13. Although the seed pattern 25 has a configuration similar to that of the seed pattern 13, the seed pattern 25 has a pattern different from that of the seed pattern 13. First, the seed pattern 25 is terminated with a round pattern 25a having a disk shape in plan view, in the round region that is represented by the dashed dotted line in the drawing and in which the pad part 12a-3 of the circuit pattern 12-3 is formed. Accordingly, the pad part 12a-3 can be formed so as to have a surface having satisfactory flatness and have a thickness comparable to that of the circuit part 12b-3.

The seed pattern 25 includes a seed pattern 25b formed in the circuit part 12b-3 connected to the pad part 12a-3 illustrated in the upper part of the drawing, and having a width W3, two seed patterns 25c and 25d formed in the circuit part 12b-4 and having a width W22 and a width W21 respectively, and two seed patterns 25e and 25f formed in the circuit part 12b-5 and having a width W12 and a width W11 respectively. Here, W3, W22, W21, W12, and W11 have a relationship expressed by expression (2) below.

W3>W22,W21,W12, and W11 (2)

In the circuit pattern 12-3, when an adjustment is made so as to, for example, make W3, the sum total of the widths W22 and W21, and the sum total of the widths W12 and W11 be substantially equal to each other, the thicknesses of the circuit parts 12b-3, 12b-4, and 12b-5 can be made substantially equal to each other. Note that the circuit parts 12b-4 and 12b-5 include the two seed patterns 25c and 25d and the two seed patterns 25e and 25f respectively while the circuit part 12b-3 includes the one seed pattern 25b, and therefore, the surface flatness is improved in the circuit parts 12b-4 and 12b-5 to a larger degree than in the circuit part 12b-3.

Note that the seed patterns 25b, 25c, 25d, 25e, and 25f are assumed to be electrically connected directly or indirectly with each other in a part not illustrated so as to have the same potentials in a plating step with the SAP. For example, the seed patterns 25c and 25d can be formed by separating the seed pattern 25b into two parts, and the seed patterns 25e and 25f can be connected to the seed patterns 25c and 25d respectively.

Fourth Modification

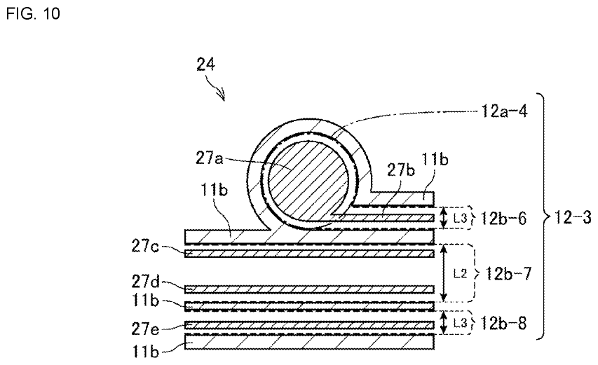

FIG. 10 is a diagram illustrating a configuration of a circuit pattern 12-4 according to a fourth modification of the circuit pattern 12 and is a diagram corresponding to FIG. 3 that illustrates the configuration of the circuit pattern 12. Note that in FIG. 10, constituent elements the same as those of the wiring layer 10 illustrated in FIG. 3 are indicated by numerals the same as those in FIG. 3, and the description of FIG. 3 given above is to be cited.

The circuit pattern 12-4 illustrated in FIG. 10 includes a pad part 12a-4 and circuit parts 12b-6, 12b-7, and 12b-8. The circuit part 12b-6 is a part connected to the pad part 12a-4. The circuit part 12b-7 is a part adjacent to the circuit part 12b-6, and the circuit part 12b-8 is a part adjacent to the circuit part 12b-7.

In this modification, specifically, the circuit part 12b-7 is formed so as to be a part wider than the circuit part 12b-6 and the circuit part 12b-8. That is, the widths L1, L2, and L3 of the circuit parts 12b-6, 12b-7, and 12b-8 have the following relationship.

L2>L1 and L3 (3)

Although the pad part 12a-4 and the circuit parts 12b-6, 12b-7, and 12b-8 of the circuit pattern 12-4 have configurations similar to those of the pad part 12a and the circuit parts 12b of the circuit pattern 12, a difference is that a seed pattern 27 is included instead of the seed pattern 13. Although the seed pattern 27 has a configuration similar to that of the seed pattern 13, the seed pattern 27 has a pattern different from that of the seed pattern 13. First, the seed pattern 27 is terminated with a round pattern 27a having a disk shape in plan view, in the round region that is represented by the dashed dotted line in the drawing and in which the pad part 12a-4 of the circuit pattern 12-4 is formed. Accordingly, the pad part 12a-4 can be formed so as to have a surface having satisfactory flatness and have a thickness comparable to that of the circuit part 12b-6.

The seed pattern 27 includes one seed pattern 27b formed in the circuit part 12b-6 connected to the pad part 12a-4 illustrated in the upper part of the drawing, two seed patterns 27c and 27d formed in the circuit part 12b-7, and one seed pattern 27e formed in the circuit part 12b-8. Here, the seed patterns 27b, 27c, 27d, and 27e have the same widths.

Accordingly, in this modification, the thickness of the circuit pattern 12-4 in the circuit part 12b-7 is prevented from being decreased relative to the thicknesses of the circuit parts 12b-6 and 12b-8, and accordingly, the uniformity of the thickness of the circuit pattern 12-4 can be improved and the flatness of the surface in the circuit part 12b-7 can also be improved.

Note that the seed patterns 27b, 27c, 27d, and 27e are assumed to be electrically connected directly or indirectly with each other in a part not illustrated so as to have the same potentials in a plating step with the SAP.

### Second Embodiment

Next, a second embodiment of the present disclosure will be described.

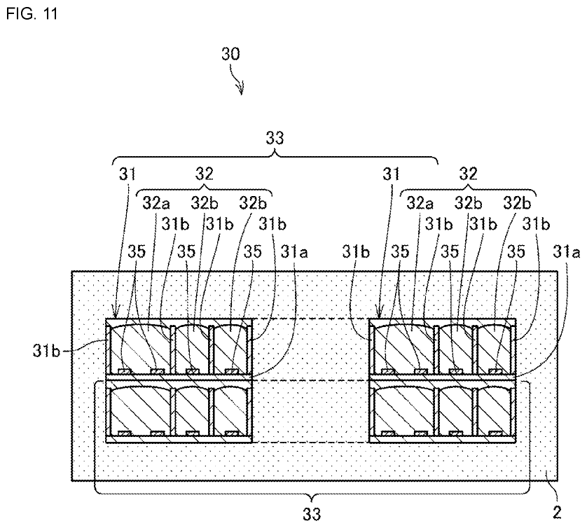

FIG. 11 is a schematic diagram illustrating an internal structure of a coil component 30 according to the second embodiment of the present disclosure and is a diagram corresponding to FIG. 1 that illustrates the internal structure of the coil component 1.

The coil component 30 includes two wiring layers 33 having a ring shape. Similarly to the wiring layer 10, each of the wiring layers 33 includes an insulating layer 31 and a circuit pattern 32 having a spiral shape and embedded in the insulating layer 31. The circuit patterns 32 in the respective wiring layers 33, which are two stacked layers, are connected to each other in respective parts thereof to form a coil part.

The insulating layer 31 includes a bottom cover layer 31a, insulating walls 31b, and a top cover layer 31c similar to the bottom cover layer 11a, the insulating walls 11b, and the top cover layer 11c of the insulating layer 11 of the wiring layer 10. The circuit pattern 32 includes a pad part 32a and circuit parts 32b similar to the pad part 12a and the circuit parts 12b of the circuit pattern 12.

The circuit pattern 32 includes, similarly to the circuit pattern 12, a seed pattern 35 that extends along the circuit pattern 32 on the upper surface of the bottom cover layer 31a, which is one surface along a main surface of the insulating layer 31. In the circuit pattern 32, in at least one part (for example, the pad part 32a) of the circuit pattern 32 along the extending direction of the circuit pattern 32, the number of seed patterns 35 when viewed in cross section orthogonal to the extending direction of the circuit pattern 32 is two, as in the circuit pattern 12.

Accordingly, in each of the wiring layers 33, the uniformity of the surface shape and thickness of the circuit pattern 32 is improved as in the wiring layer 10 described above. Therefore, the reliability of the connection part between the circuit patterns 32 of the two respective wiring layers 33 can be increased. Similarly, the reliability of the connection part between the circuit pattern 32 of the wiring layer 33 and another wiring pattern (for example, a wiring pattern connected to an outer electrode) can also be increased.

Although the coil component 30 includes two wiring layers 33 in this embodiment, the coil component 30 may include three or more wiring layers 33 that are stacked. The circuit pattern of each of these stacked wiring layers can have two or more seed patterns in any part in which the uniformity of the surface shape and/or thickness of the circuit pattern is required in accordance with the design of the coil component 30.

According to the embodiments and modifications described above, the following effects are attained.

The coil component 1 described above includes the insulating layer 11 that has a main surface and the circuit pattern 12 that is embedded in the insulating layer 11 and extends along the main surface. The circuit pattern 12 includes the seed pattern 13 that extends along the main surface within the circuit pattern 12, and in a cross section orthogonal to the extending direction of the circuit pattern 12, the circuit pattern 12 has a part in which the number of seed patterns 13 is two or more.

With this configuration, the uniformity of the structure including the thickness and/or surface shape of the circuit pattern 12 can be improved.

In the cross section described above, the insulating layer 11 includes two insulating walls 11b between which the circuit pattern 12 is sandwiched along the arrangement direction of the seed patterns 13. For one insulating wall 11b of the insulating walls 11b, the distance W1 from the insulating wall 11b to the seed pattern 13 closest to the insulating wall 11b and the space W2 between the seed patterns 13 preferably have the relationship

W1×2<W2.

With this configuration, the uniformity of the thickness of the circuit pattern 12 can be effectively improved.

Two or more circuit patterns 32 are arranged in a direction orthogonal to the main surface. With this configuration, the circuit patterns having improved thickness uniformity can be formed in a multilayer structure.

The seed pattern 13 has a part having a ring shape within the circuit pattern 12. With this configuration, for example, the uniformity of the thickness of the circuit pattern 12 in the pad part 12a having a round shape in plan view can be improved.

For example, the seed pattern 23 has a part having an X letter shape within the circuit pattern 12-2. With this configuration, similarly to the above, for example, the uniformity of the thickness of the circuit pattern 12 in the pad part 12a having a round shape in plan view can be improved.

For example, the seed pattern 27 has, within the circuit pattern 12-4, two or more parts that extend in parallel along the circuit pattern 12-4. With this configuration, for example, the thicknesses of the two parts, in the circuit pattern 12-4, having different widths can be made substantially equal to each other, and the uniformity of the thickness of the circuit pattern 12-4 can be improved.

Note that any of the embodiments and modifications described above illustrates one aspect of the present disclosure and can be modified and applied as desired without departing from the spirit of the present disclosure.

Although the coil components 1 and 30 have been described as examples in the embodiments described above, the present disclosure is also applicable to any electronic component, other than the coil components, including at least one wiring layer having a structure similar to that of the wiring layer 10, 20, 22, 24, 26, or 33. The shape of such a wiring layer in plan view is not limited to a ring shape and may be any shape in accordance with the circuit design of the electronic component.

Although the circuit pattern 12 has a spiral shape in the embodiment described above, the shape is not limited to this and may be, for example, a circling shape having less than one turn, a linear shape, or a meander shape.

Although the end surface of the lead line 14 functions as the outer electrode 15 in the embodiment described above, the outer electrode 15 is not limited to this and may be separately formed on the end surface of the lead line 14. In this case, the outer electrode 15 can be formed with any forming method, such as coating, plating, or sputtering and may be made of any material, such as copper, silver, nickel, tin, or gold. The outer electrode 15 may have a layered structure including a plurality of different layers.

Although the insulating layer 11 is an insulating resin in the embodiment described above, the insulating layer 11 may be, for example, sintered glass, sintered alumina, or sintered ferrite. The insulating layer 11 may have a configuration the same as that of the base body 2 and may be integrated with the base body 2.

Any of the characteristic configurations illustrated in the embodiments and modifications described above can be combined and used in any electronic component. For example, an electronic component can include a combination of any number of any wiring layers having a configuration similar to those of the wiring layers 10, 20, 22, 24, 26, and 33 described above.

Unless otherwise stated, the directions, such as the horizontal and vertical directions, and various numerical values, shapes, and materials in the embodiments described above include a scope (the scope of equivalents) with which effects equivalent to those attained with the directions, numerical values, shapes, and materials are attained.

The embodiments and modifications described above support the following configurations.

(Configuration 1) A coil component including: an insulating layer that has a main surface; and a circuit pattern that is embedded in the insulating layer and extends along the main surface, in which the circuit pattern includes a seed pattern that extends along the main surface within the circuit pattern, and in a cross section orthogonal to an extending direction of the circuit pattern, the circuit pattern has a part in which the number of seed patterns is two or more.

(Configuration 2) The coil component according to Configuration 1, in which in the cross section, the insulating layer includes two insulating walls between which the circuit pattern is sandwiched along an arrangement direction of the seed patterns, and for one insulating wall of the insulating walls, a distance W1 from the insulating wall to a seed pattern closest to the insulating wall among the seed patterns and a space W2 between the seed patterns have a relationship W1×2<W2.

(Configuration 3) The coil component according to Configuration 1 or 2, in which the circuit pattern includes two or more circuit patterns that are arranged in a direction orthogonal to the main surface.

(Configuration 4) The coil component according to any of Configurations 1 to 3, in which the seed pattern has a part having a ring shape within the circuit pattern.

(Configuration 5) The coil component according to any of Configurations 1 to 4, in which the seed pattern has a part having an X letter shape within the circuit pattern.

(Configuration 6) The coil component according to any of Configurations 1 to 5, in which the seed pattern has, within the circuit pattern, two or more parts that extend in parallel along the circuit pattern.

What is claimed is:

1. A coil component comprising:
an insulating layer that has a main surface; and
a circuit pattern that is embedded in the insulating layer and extends along the main surface, wherein
the circuit pattern includes a seed pattern that extends along the main surface within the circuit pattern, and
in a cross section orthogonal to an extending direction of the circuit pattern, the circuit pattern has a part in which a number of seed patterns is two or more.

2. The coil component according to claim 1, wherein
in the cross section, the insulating layer includes two insulating walls between which the circuit pattern is sandwiched along an arrangement direction of the seed patterns, and for one insulating wall of the insulating walls, a distance W1 from the insulating wall to a seed pattern closest to the insulating wall among the seed patterns and a space W2 between the seed patterns have a relationship W1×2<W2.

3. The coil component according to claim 1, wherein
the circuit pattern includes two or more circuit patterns that are arranged in a direction orthogonal to the main surface.

4. The coil component according to claim 1, wherein
the seed pattern has a part having a ring shape within the circuit pattern.

5. The coil component according to claim 1, wherein
the seed pattern has a part having an X letter shape within the circuit pattern.

6. The coil component according to claim 1, wherein
the seed pattern has, within the circuit pattern, two or more parts that extend in parallel along the circuit pattern.

7. The coil component according to claim 2, wherein
the circuit pattern includes two or more circuit patterns that are arranged in a direction orthogonal to the main surface.

8. The coil component according to claim 2, wherein
the seed pattern has a part having a ring shape within the circuit pattern.

9. The coil component according to claim 2, wherein
the seed pattern has a part having an X letter shape within the circuit pattern.

10. The coil component according to claim 2, wherein
the seed pattern has, within the circuit pattern, two or more parts that extend in parallel along the circuit pattern.
